(19) United States
(12) Patent Application Publication
(10) Pub. No.: US 2015/0037116 A1
(43) Pub. Date: Feb. 5, 2015

(54) FASTENING ELEMENT HAVING A SPRING SHANK, AND COMPOSITE STRUCTURE

(71) Applicant: F. ZWEI GMBH, Paderborn (DE)

(72) Inventor: JUERGEN FABRICIUS, PADERBORN (DE)

(21) Appl. No.: 14/450,405

(22) Filed: Aug. 4, 2014

(30) Foreign Application Priority Data
Aug. 2, 2013 (DE) 202013103484.3

(51) Int. Cl. F16B 39/24

(52) U.S. Cl. CPC F16B 39/24
USPC 411/112

(57) ABSTRACT

A fastening element for fastening a base plate on a substructure having a web-shaped edge region includes a rotary drive and a screw spring element formed from a spring wire. A rotational axis of the rotary drive and a spring axis of the screw spring element are coaxial. The fastening element having a shank to which the screw spring element is fastened with a first end of the spring wire. The screw spring element is rotated about the spring axis via the rotary drive. The opposite free end of the screw spring element having, as a threading aid, a pitch widening which grips the web-shaped edge region of the substructure upon rotation and clamps the edge in the screw spring element upon further rotation.

### CROSS-REFERENCE TO RELATED APPLICATION

This application claims the priority, under 35 U.S.C. §119, of German patent application DE 20 2013 103 484.3, filed Aug. 2, 2013; the prior application is herewith incorporated by reference in its entirety.

### BACKGROUND OF THE INVENTION

### Field of the Invention

The invention relates to a fastening element for fastening a component on a substructure having a web-shaped edge region, which fastening element has a rotary drive and a multiple-turn screw spring element which is formed from a spring wire, and in which fastening element a rotational axis of the rotary drive and a spring axis of the screw spring element are identical.

The fastening element is provided, in particular, for base plates which are subjected to different loads.

Transport floors of superstructures, trailers and semi-trailers of trucks are predominantly produced from wood. These are usually wooden boards made from plywood or simple wooden planks. So-called wire mesh plywood boards are frequently used. The floor boards are to be fastened on the substructure of the transport means. The floors of small transport vehicles and trailers for passenger motor vehicles, of motor homes and caravans, of buses and different rail vehicles are also frequently composed of wooden boards. The wooden floors have up to now frequently been fastened to the substructure by way of screws, rivets or by way of adhesive.

In order to make the mechanical fastening of the wooden planks on the substructure possible, it is as a rule necessary to first of all provide the wooden plank and the substructure with holes. In order to save this preliminary work, it is nowadays generally customary to use self-tapping screws. The different work operations of drilling, thread cutting and tightening are carried out by self-tapping screws in one work operation.

However, fastening points which are provided by way of self-tapping screws tend to corrode relatively rapidly. This is a result of the fact that a considerable part of the drilling chips, a mixture of wood and metal, are not discharged from the fastening hole and the fastenings are subjected on their underside to the weathering influences of driving operation (spray water, snow, salt, dirt, etc.). The mixture of chips which is clamped in between the screw head and the substructure becomes rapidly soaked completely with the contaminated spray water and dries only in a very slow manner. The screw tip and the lower part of the screw hole are also susceptible to corrosion.

In addition, mechanical fastenings in conjunction with plywood wooden boards have to withstand the customary chassis torsions, especially in the case of long vehicles, and therefore high bending and shear loads. It often occurs here that screws are snapped off.

Since the vehicle substructures are increasingly produced from high strength steel, which makes the use of thinner and thinner steel sheets possible, the machining of self-tapping screws becomes more and more difficult. Frequently, either the steel quality of the self-tapping screws is no longer sufficient to drill into the high strength steel and to cut a thread, or the available material thickness is not sufficient for secure fastening of the wooden plank on the substructure. In cases of this type, pre-drilling inevitably has to be carried out again, the pre-drilling of the high strength steels also being problematical, however, even by way of powerful drills, to the extent that the drills have only low service lives.

U.S. Pat. No. 3,260,149 describes a fastener for vehicle license plates, in which fastener a spring on a rotary button is rotated through two holes which lie partially one above another and in this way the license plate is clamped fixedly on the car.

U.S. Pat. No. 5,704,748 describes a machine screw, on the thread turns of which a spring is placed. The spring is to be clamped in the thread turns and therefore secure the screw in the case of vibrations and also at high temperatures. The spring is not suitable for absorbing the connecting forces on its own.

German published patent application DE 1 907 793 describes a screw with a shank that is configured as a spring with a sharp end. It is provided for connecting an elastomeric object to a carrier. It is rotated into the elastomeric object through a hole in the carrier. The fastening element in U.S. Pat. No. 4,762,453 and its counterpart British patent application GB 2 186 937 has a similar configuration. The screw shank that is provided there is provided for screwing into a soft material.

### SUMMARY OF THE INVENTION

It is accordingly an object of the invention to provide a fastening element with a spring shaft which overcomes the disadvantages of the heretofore-known devices of this general type and which provide for a composite system for fastening a base plate on a substructure by way of a fastening element, which makes it possible to avoid corrosion at the fastening point and also makes processing possible in conjunction with high steel strengths. Moreover, the composite system to be proposed is to be resilient with respect to torsions of the substructure.

With the above and other objects in view there is provided, in accordance with the invention, a fastening element for fastening a base plate on a substructure having a web-shaped edge region, the fastening element comprising:

a rotary drive and a shank connected to the rotary drive, the rotary drive defining a rotational axis or the fastening element;

a screw spring element mounted to the shank and having a spring axis identical to the rotational axis;

the screw spring element being formed of a spring wire having a first end attached to the shank, wherein the screw spring element can be rotated about the spring axis by rotating the rotary drive;

the spring wire of the screw spring element further having a free end opposite the first end formed with a pitch widening being a threading aid configured to grip the web-shaped edge region of the substructure upon being rotated and to clamp the edge within the screw spring element upon further rotation.

The fastening element according to the invention for fastening a base plate on a substructure comprises a multiple-turn screw spring element, which has a spring wire, and a rotary drive, a rotational axis of the rotary drive and a spring axis of the screw spring element being identical, and the fastening element having a shank, to which the spring screw element is fastened by way of a first end of the spring wire, with the result that the screw spring element can be rotated about the spring axis via the rotary drive and the opposite free end of the screw spring element has, as a threading aid, a pitch widening which grips a web-shaped edge region of the substructure upon rotation and clamps the edge in the screw spring element upon further rotation.

The fastening element according to the invention therefore combines functionalities of a screw with those of a spring, the rotary drive as drive for the screw spring element and the screw spring element having the function of a thread which can be prestressed and is prestressed during screwing in of the fastening element.

In one embodiment, the rotary drive has a screw head drive. The latter can be configured, for example, as a countersunk head, cylindrical head, hexagonal head, pan head and countersunk pan head.

In order to achieve secure clamping of the base plate on the substructure, it is provided in one embodiment of the invention that the screw spring element has a screw spring pitch width which is smaller than or equal to an expected thickness of the web-shaped edge to be gripped of the substructure.

Clamping of the screw spring element on the rotary drive is achieved by virtue of the fact that the screw spring element has an inner diameter which is smaller than or equal to an outer diameter of a shank of the rotary drive, and the shank is received partially in an inner region of the screw spring element.

Here, the shank can widen from its free end to its screw head drive in a stepped or continuous manner to a width which is greater than the inner diameter of the screw spring element in its relaxed state.

The screw spring element is formed with a round or polygonal cross section and is connected to the shank in a non-positive and positively locking manner in such a way that even great torques can be transmitted.

In order to fasten the rotary drive to the screw spring element such that it cannot rotate with regard to a rotational movement about the rotational axis, it is provided in another embodiment that, at its free end, the shank has a groove which extends transversely with respect to the rotational axis or a passage which extends transversely with respect to the rotational axis, through which the first end of the spring wire is guided in an angled-away manner.

In order firstly to facilitate the insertion operation and in order for it to be possible secondly to achieve a particularly stable connection between the base plate and the substructure, it is provided in one embodiment of the invention that the screw spring element is a conical spring with a narrow end and with a wide end, the screw spring element being fastened via the wide end to the rotary drive.

The rotary drive can be composed of metal or of plastic. The latter is preferably molded onto the screw spring element. Here, the inwardly angled-away spring wire end is preferably left exposed, with the result that it is engaged around by an open-end wrench during the screwing-in operation. The plastic then serves substantially to seal the hole in the base plate. The fastening element according to the invention can be composed of two materials, for instance with a rotary drive which is composed substantially or exclusively of plastic and a screw spring element which is composed substantially or exclusively of spring steel. It is also possible, however, that the screw spring element is composed of a resilient plastic.

Various possible combinations of the materials for the rotary drive and the screw spring element therefore result. For instance, the rotary drive with shank can be produced from hardened carbon steel, from austenitic stainless steel, from aluminum or else from plastic, for example polyvinyl chloride (PVC) or glass reinforced plastics (GRP).

The screw spring element can also be produced from hardened carbon steel, from austenitic stainless steel or else from plastic, for example GRP. All combinations are possible, even “casting in one piece” production using plastic or GRP.

In one embodiment, the screw spring element forms a multiple-turn thread which is fastened at one end to the rotary drive and at the other end has a tapered free screw turn with an increasing lead. In another embodiment, the screw shank has a screw thread which engages into the screw spring element in a fitting manner.

In yet another embodiment, the spring wire is composed of flattened round wire, the flat sides of which are oriented radially with respect to the axis of the screw spring element.

With the above and other objects in view there is also provided, in accordance with the invention, a composite system, comprising:

a substructure and a base plate disposed on the substructure and having at least one hole formed therein;

a fastening element as described above that is inserted into the at least one hole and connects the base plate to the substructure;

the substructure being disposed to cover the at least one hole partially by way of an edge region, and wherein the edge region is clamped by at least one free screw turn of the screw spring element.

In other words, a composite system comprising a substructure and a base plate which is arranged thereon with at least one hole is formed by way of an above-described fastening element which is inserted into the hole. Here, the substructure covers each hole partially by way of an edge region and the edge region is clamped by at least one free screw turn of the screw spring element. A connection between the base plate and the substructure is thus produced, which connection holds and does not snap off even in the case of torsions of the substructure. Here, the composite system is set up in such a way that the substructure can be composed of hardened steel and has a thickness which is multiple times smaller than the base plate.

The fastening element according to the invention is preferably used in such a way that the base plate has pre-drilled holes. The edge region is situated on the edge side of the substructure and/or in an aperture of the substructure. The pre-drilled holes are arranged in such a way that that edge of the substructure, on which the fastening element is to act, is situated below the pre-drilled hole. It is important that, starting from the top side of the base plate, the fastening element according to the invention can be inserted into the pre-drilled hole in such a way that the screw spring element can engage behind the edge with its free end which faces away from the rotary drive.

The base plate can be pre-drilled with a diameter which is slightly smaller than the outer diameter of the screw spring element. If the spring wire of the screw spring element then has a polygonal cross section or it has another toothing system which is formed on the outer circumference of the screw spring element, or if the spring wire has at least two part wires which are twisted with one another, it is achieved that the screw spring element cuts into the inner circumference of the pre-drilled hole of the base plate when the fastening element according to the invention is screwed in, with the formation of a thread, with the result that further positively locking fixing of the fastening element is achieved in the screwed-in state of the fastening element according to the invention. For this purpose, the screw spring element can also have knurling on its outer circumference. As an alternative or in addition, it can be provided that the screw head of the screw head drive has an under-head toothing system.

The fastening element according to the invention has the special advantage that, depending on the type of use, the pre-drilled hole of the substructure is dispensable, as a result of which the formation of particularly corrosion-susceptible drilled points in the substructure can be avoided. This is therefore possible because the screw spring element is a fastening means which is hollow in the interior, with the result that a base plate can also be fastened to an edge of the substructure in such a way that the edge enters between the windings of the screw spring element into the interior of the screw spring element, with the result that, during tightening of the fastening element according to the invention, the base plate is clamped on the edge of the substructure.

In one embodiment, the holding and/or edge region is arranged on the edge side of the substructure and/or of an aperture of the substructure.

In one embodiment, the substructure is composed of hardened steel and has a thickness which is multiple times smaller than the base plate. The aperture can be formed by a cutout with a pressed-out tongue. Here, the tongue can protrude into the hole and can be engaged behind by the free screw turn of the screw spring element, tangent to it in a linear and/or laminar manner.

In another embodiment, a region of the screw shank which is threadless and close to the head can hold the screw spring element in a widened state in the hole in a non-positive and, penetrated radially, positively locking manner.

The substructure can consist of profiled steel sheet and the base plate can consist of substantially thicker, wooden planks or boards. Here, the substructure can be composed of hot worked, hardened steel.

The screw spring element can have a smaller spacing in each case from turn to turn than the thickness of the steel sheet in the holding region.

According to a further embodiment, the holding and/or edge region is situated in the substructure on both sides of an undercut groove which is narrower than an outer diameter of the screw spring element, with the result that it engages into both undercut grooves. Here, the screw spring element can have a double start and each undercut groove region can be engaged behind by a spring turn end.

In order to avoid corrosion on account of moisture which penetrates into the connecting point, it is provided in one embodiment of the composite system that the hole with the screw spring element is provided with a sealing plastic filling.

Other features which are considered as characteristic for the invention are set forth in the appended claims.

Although the invention is illustrated and described herein as embodied in a fastening element having a spring shank, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a detail of a cargo bay floor with a base plate that is fastened in accordance with the prior art;

FIG. 2 shows one embodiment of the fastening element according to the invention;

FIG. 3A to FIG. 3D show exploded views of further embodiments of the fastening elements according to the invention;

FIG. 4A to FIG. 4C show embodiments of the screw spring element according to the invention;

FIG. 5 shows a section through a base plate with a screwed-in straight fastening element on a substructure;

FIG. 6 shows a section through a base plate with a screwed-in conical fastening element on a substructure;

FIG. 7 shows a section through a base plate with a double-start fastening element on a substructure with groove;

FIG. 8 shows a view of a base plate with fastening element; and

FIG. 9 shows a section through a base plate with a screwed-in straight fastening element on a substructure with a pressed-out tongue.

### DETAILED DESCRIPTION OF THE INVENTION

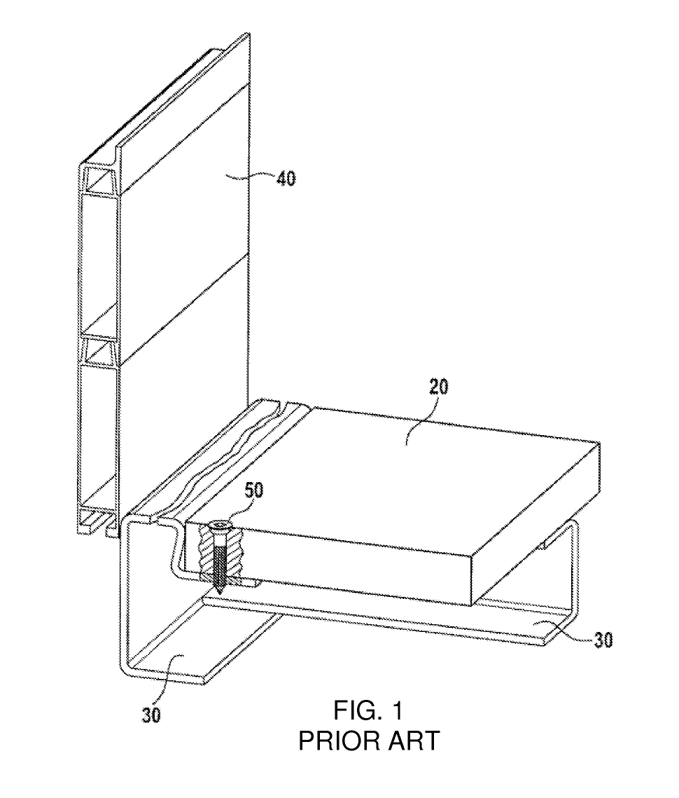

Referring now to the figures of the drawing in detail and first, particularly, to FIG. 1 thereof, there is shown a detail of a cargo bay, in which the base plate 20 is fastened by way of a self-tapping screw 50 to a crossmember of a substructure 30. A wall element 40 adjoins the substructure. It is customary according to the prior art to first of all place the base plate 20 on the carriers of the substructure and subsequently, when it is moved into position, to fasten it with the aid of self-tapping screws on the substructure 30. To this end, the self-tapping screws 50 are screwed by way of corresponding mounting devices through the base plate 20 into the substructure. Here, the self-tapping screw 50 drills both through the base plate 20 and through the substructure 30, the self-tapping screw being designed, at least when penetrating the substructure 30, to form a thread in the circumference of the hole which is formed, with the result that a non-positive connection between the base plate and the substructure can be produced by way of the insertion of the self-tapping screw 50 through the base plate 20 and the substructure 30.

The self-tapping screw 50 is configured as a countersunk head screw, in order to form a flat working surface. A mixture of wood and metal chips is collected in the drilled hole of the substructure, which mixture binds moisture and therefore promotes the corrosion in the bored or drilled hole region. Furthermore, it is disadvantageous that the high strength steels which are used for the substructure require the production of the self-tapping screws 50 from even higher quality steels, in order that they can penetrate through the substructure 30. The connection which is produced with the aid of the self-tapping screw 50 between the base plate 20 and the substructure 30 is clearly a rigid connection, with the result that stresses are produced between the base plate 20 and the substructure 30 in the case of torsion of the substructure during driving operation, which can lead to individual self-tapping screws 50 being ripped out.

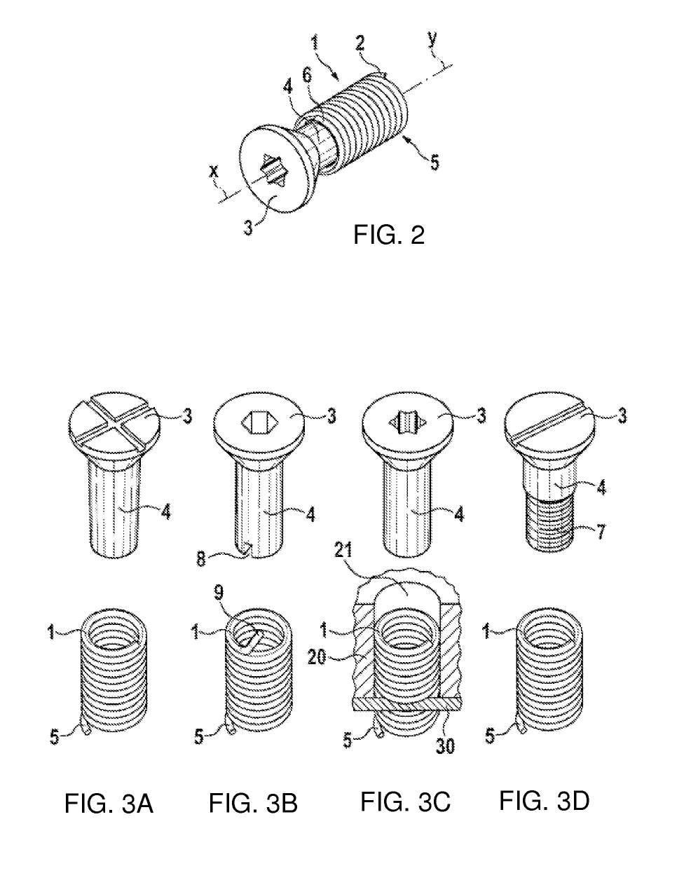

FIG. 2 shows one embodiment of the fastening element according to the invention. The embodiment has a screw spring element 1 which, in the illustrated embodiment, consists of a screw spring formed from a spring wire 2. In principle, the screw spring pitch can be adapted to the material thickness to be worked of the substructure, preferably in such a way that the screw spring pitch is at least slightly smaller than the expected material thickness. It is achieved in this way that, during screwing of the fastening element according to the invention through a pre-drilled hole in a base plate and a pre-drilled hole in a substructure, the screw spring element emerges in its end position at least with one winding, but preferably with a plurality of windings, through the hole of the substructure on the underside of the substructure, with the result that, during tightening of the fastening element according to the invention, a portion of the screw spring element which is situated above the underside of the substructure is prestressed, with the result that the base plate is pressed against the substructure and therefore a connection between the base plate and the substructure is produced which is stable but is resilient in the case of high loads, as can occur as a result of twisting of the substructure during driving operation. It goes without saying that, to this end, the rotary drive 3 is fastened such that it cannot rotate to the shank 4 with respect to the screw spring element 1 with regard to rotational movements about the rotational axis x of the rotary drive 3 at the start 6 of the spring wire 2, in order that a reliable screwing-in movement of the screw spring element can be carried out via the rotary drive 3. The inner diameter of the screw spring element 1 is preferably selected precisely in such a way that it corresponds substantially to the outer diameter of a shank 4 of the rotary drive 3. This ensures that the rotational axis x of the rotary drive and the spring axis y of the screw spring element 1 coincide.

At its end which faces away from the rotary drive, the screw spring element 1 has precisely one pitch widening 5, in order to engage behind the underside of the metal structure during insertion of the fastening element into the aligned or at least overlapping pre-drilled holes of the base plate and substructure.

As is shown by way of example in FIG. 3A to FIG. 3D, the rotary drive which is preferably configured as a screw head drive can have substantially any desired geometries. The rotationally secure fastening between the rotary drive 3 and the screw spring element 1 can also be configured in various ways. In the embodiment according to FIG. 3A, the shank 4 or stem 4 is split in two and has a thicker end which faces the screw head and a thinner end which faces the screw spring element 1, the thinner end having precisely a diameter which corresponds to the inner diameter of the screw spring element 1, or is slightly greater than the inner diameter of the screw spring element 1, in order to achieve clamping of the screw spring element 1 on the thinner end of the stem 4.

In the embodiment according to FIG. 3B, a groove 8 which extends in the longitudinal direction of the shank 4 from its free end is made at the end of the shank 4, into which groove 8 a free radial end 9 of the screw spring element can be inserted for fastening the two components to one another such that they cannot rotate.

In the embodiment according to FIG. 3C, the screw spring element can extend over the entire length of the shank 4. If the screw spring element 1 has a toothing system or the like on its outer circumference, said toothing system can serve, during screwing of the fastening element according to FIG. 3C into the base plate 20 which is shown in sectioned form, to introduce a thread into its hole 21, with the result that, when the fastening element is inserted, fixing of the latter is also achieved via the base plate and on the substructure 30.

In the embodiment according to FIG. 3D, a thread 7 is made at the free end of the shank 4, over which thread 7 the screw spring 1 can be screwed. At their end, all the embodiments have a threading aid 5 which is configured precisely by a pitch widening. Said pitch widening can be achieved in the simplest case by virtue of the fact that the lower end of the spring wire of the screw spring element is bent up.

One embodiment is not shown, in which the shank of the rotary drive has a passage which extends transversely with respect to the rotational axis x and has a cross section which corresponds substantially to the cross section of the spring wire of the screw spring element which is used, the first end of the spring wire being guided through the passage.

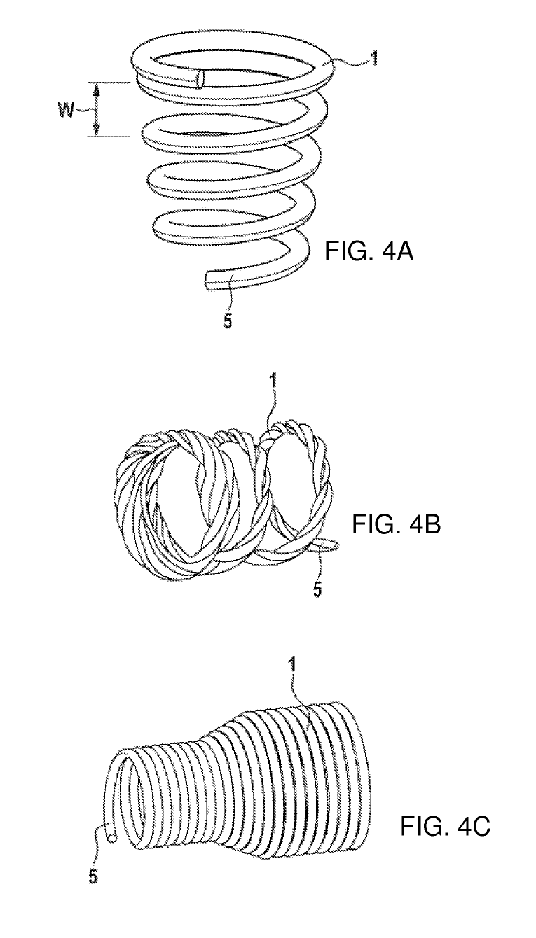

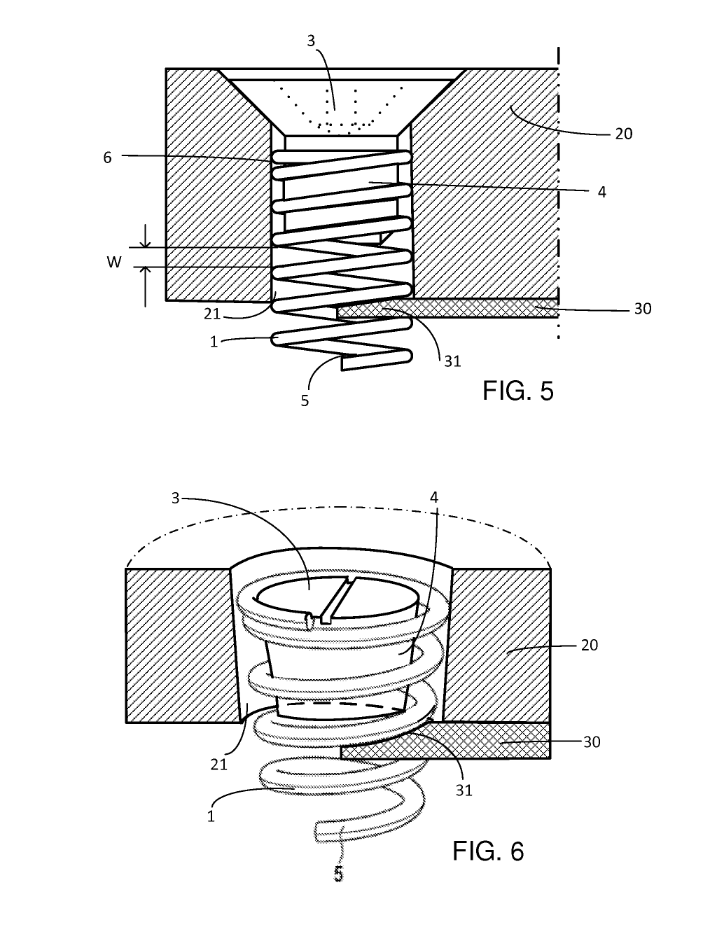

FIG. 4A to FIG. 4C show exemplary embodiments for screw spring elements 1. Here, FIG. 4A shows a screw spring element 1 which is configured as a conical spring. The screw spring element 1 can, for example according to one of the embodiments of FIG. 3A to FIG. 3D, be fastened via its wide end to a rotary drive 3. The narrow end with the pitch widening 5 then simplifies the insertion of the fastening element through the aligned or at least overlapping holes in the base plate and substructure. During the screwing-in operation, the cross section of the screw spring element 1 which bears against the underside of the substructure is widened, with the result that reliable fastening between the base plate and the substructure is achieved. The pitch width W is configured to be smaller than a sheet thickness of the substructure which is to be engaged over.

In the embodiment according to FIG. 4B, the screw spring element 1 is formed from two twisted spring wires. Said embodiment has the advantage that, in the case where the pre-drilled hole in the base plate is selected to be slightly smaller than the outer diameter of the screw spring element 1, reliable clamping of the screw spring element 1 on the circumference of the hole and therefore secure holding of the fastening element according to the invention in the inserted state is achieved during screwing in of the screw spring element through the base plate.

In the embodiment according to FIG. 4C, the screw spring element is configured as a tension spring and has a first section with a first spring diameter and a second section with a second, smaller spring diameter, the spring diameter moving from the wide diameter to the narrow diameter in a transition region between the first and the second region.

FIG. 5 shows the fastening element according to the invention in a pre-drilled base plate 20. The substructure 30 does not have a pre-drilled hole. The hole 21 in the base plate 20 is positioned precisely in such a way that it overlaps one edge 31 of the substructure 30. If a fastening element according to the invention is then inserted via the hole 21 into the base plate 20, the free end of the spring wire of the screw spring element 1 can engage via its pitch widening 5 behind the edge 31 of the substructure 30 and clamp itself fixedly to the latter. The screw spring element 1 is fastened at its start 6 to the shank 4, and has a pitch width W which is smaller than the thickness of the edge 31, with the result that tensioning of the substructure 30 on the base plate 20 is achieved by way of further screwing in of the fastening element on its rotary drive 3 and correspondingly by way of the prestress which is produced in the process of that portion of the screw spring element which is situated above the underside of the substructure 30.

FIG. 6 shows a section through a base plate 20 on a substructure 30 with a conical spring which is inserted into a conical hole 21 as screw spring element 1. The conical spring is fastened to the shank 4, in which a slot is machined as rotary drive 3. After threading in via the pitch widening 5, the conical spring is clamped fixedly on the edge 31. During further rotation, the conical spring is also seated fixedly in the conical hole 21.

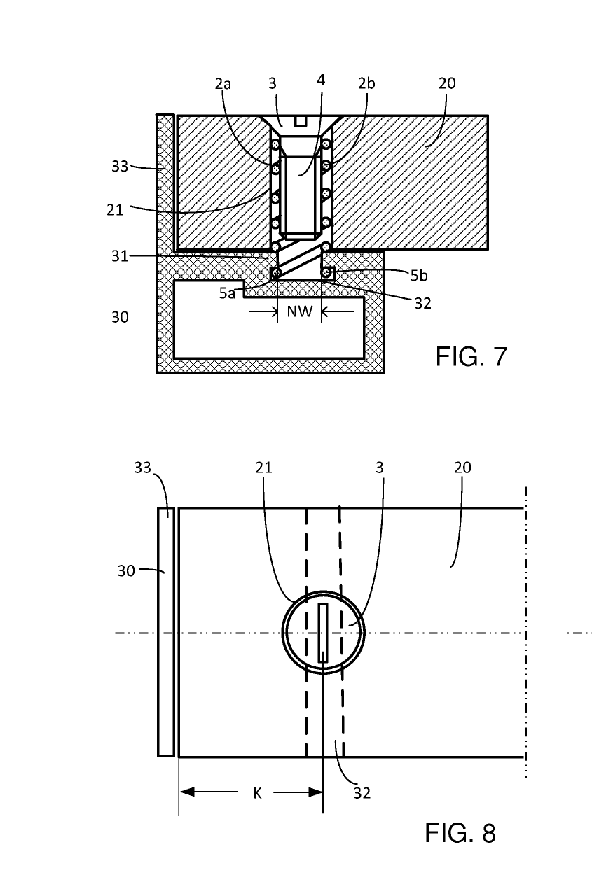

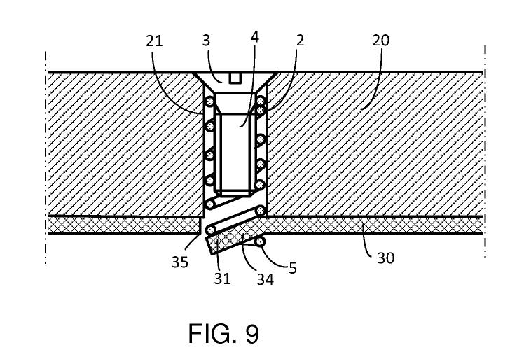

FIG. 7 and FIG. 8 show a further alternative embodiment. The substructure 30 preferably consists of a drawn lightweight metal profile material. A C-shaped groove 32 is machined continuously into the latter, the upper opening of which groove 32 has a groove width NW which is smaller than the diameter of the hole 21. The two helix ends 5a, 5b are therefore supported on the two edges 31. The helix ends 5a, 5b engage in each case under one of the undercut groove regions. If the screw spring element 1 is double-start, as shown in FIG. 7, the two spring wires 2a, 2b extend offset by 180° around the shank 4 from the rotary drive 3, with the result that both helix ends 5a, 5b enter into the groove 32 on different sides and engage under and clamp in the two edges 31 in each case in an associated manner.

Since the groove 32 runs transversely under the end region of the base plate/plates, the holes 21 can be made in each case in an optimum, for example central, manner in the base plate 20 and, in particular, in the individual planks; merely a predefined edge spacing K is to be maintained. A stop 33 which extends behind the lateral end of the base plate 20 is advantageously situated on the profile material at the same spacing K. The centering of the hole 21 with respect to the groove 32 is ensured as a result.

FIG. 9 shows a further embodiment of the composite system. A cut-out tongue 34 is pressed out of the support surface of the substructure 30 below the hole 21 of the base plate 20, with the result that an aperture 35 permits the passage of the spring end 5. The tongue 34 is advantageously offset, with the result that the helix end 5 engages behind and, in particular, also under said tongue 34. A non-positive connection which is active in three axes is produced in this way between the helix end 5 and the substructure 30 and therefore also the base plate 20 on the latter.

1. A fastening element for fastening a base plate on a substructure having a web-shaped edge region, the fastening element comprising:
a rotary drive and a shank connected to said rotary drive, said rotary drive defining a rotational axis or the fastening element;
a screw spring element mounted to said shank and having a spring axis identical to said rotational axis;
said screw spring element being formed of a spring wire having a first end attached to said shank, wherein said screw spring element can be rotated about said spring axis by rotating said rotary drive;
said spring wire of said screw spring element further having a free end opposite said first end formed with a pitch widening being a threading aid configured to grip the web-shaped edge region of the substructure upon being rotated and to clamp the edge within the screw spring element upon further rotation.

2. The fastening element according to claim 1, wherein said screw spring element has a screw spring pitch width smaller than or equal to a nominal thickness of the web-shaped edge of the substructure to be gripped.

3. The fastening element according to claim 1, wherein said screw spring element has an inner diameter smaller than or equal to an outer diameter of said shank formed on said rotary drive, and said shank is received partially in an inner region of said screw spring element and/or said shank is formed with a groove at a free end thereof or with a throughhole, said groove or throughhole extending transversely with respect to said rotational axis, and said first end of said spring wire is guided therethrough in an angled-away manner.

4. The fastening element according to claim 1, wherein said shank is formed with a screw thread configured to mesh with said screw spring element.

5. The fastening element according to claim 1, wherein said shank widens from a free end thereof to said drive formed on a screw head in a stepped or continuous manner to a width that is greater than an inner free cross section of said screw spring element in a relaxed state of said spring wire.

6. The fastening element according to claim 1, wherein said screw spring element is a conical spring with a narrow end and with a wide end, and wherein said wide end of said screw spring element is fastened to said shank.

7. The fastening element according to claim 1, wherein said rotary drive is formed of a material selected from the group consisting of metal and plastic, and said screw spring element formed of a material selected from the group consisting of metal and plastic.

8. The fastening element according to claim 6, wherein said rotary drive is composed of plastic and is molded onto said screw spring element.

9. A composite system, comprising:
a substructure and a base plate disposed on said substructure and having at least one hole formed therein;
a fastening element according to claim 1 inserted into said at least one hole connecting said base plate to said substructure;
said substructure being disposed to cover said at least one hole partially by way of an edge region, and wherein said edge region is clamped by at least one free screw turn of said screw spring element.

10. The composite system according to claim 9, wherein said edge region is arranged on an edge side of said substructure and/or of an aperture of said substructure.

11. The composite system according to claim 10, wherein said substructure is composed of hardened steel and has a thickness which is multiple times smaller than a thickness of said base plate.

12. The composite system according to claim 10, wherein said aperture is a cutout with a pressed-out or a pressed-in tongue, and said tongue is engaged behind by a screw turn of the screw spring element.

13. The composite system according to claim 10, wherein, in said substructure, said edge region is situated on both sides of an undercut groove which is narrower than an outer diameter of said screw spring element, wherein said edge region engages into both undercut groove regions.

14. The composite system according to claim 13, wherein said screw spring element has a double start and each said undercut groove region is engaged behind by a pitch widening.

15. The composite system according to claim 9, wherein said screw spring element is a conical spring having a wide end disposed at said rotary drive, and said plate is formed with a conical hole adapted to said conical spring with an undersize relative to said conical spring.
